(19) United States
(12) Patent Application Publication
(10) Pub. No.: US 2016/0272480 A1
(43) Pub. Date: Sep. 22, 2016

(54) SMART SADDLE APPARATUS

(71) Applicant: Ahmed Abdulla Mohammed MAJJAN, Dubai (AE)

(72) Inventor: Ahmed Abdulla Mohammed MAJJAN, Dubai (AE)

(21) Appl. No.: 14/661,084

(22) Filed: Mar. 18, 2015

(51) Int. Cl. B68C 1/02; G06K 9/00; H02S 30/00; A01K 29/00

(52) U.S. Cl. CPC B68C 1/02; A01K 29/005; G06K 9/00671; H02S 30/00

(57) ABSTRACT

There is provided a saddle apparatus comprising a saddle housing comprising external walls, an internal cavity defined by the external walls and a seat portion for seating an animal rider; a container compartment defined within the internal cavity of the saddle housing; a fluid container adapted to be removably mounted inside the container compartment, the fluid container being adapted to store fluid; and a fluid dispenser in fluid communication with the fluid container adapted to allow flow of fluid from the fluid container on the animal when the saddle apparatus is mounted on the back of the animal. The saddle apparatus optionally comprises at least one of a thermometer, a gyroscope, a proximity detector and a camera, a light detector and a lighting device, a weighting device, a heart pulse reader, a user interface and a transmitter. The saddle apparatus also comprises a power supply, preferably a solar-based power supply.

### FIELD OF THE INVENTION

The present invention relates to saddles for animals, such as horses and camels, and more particularly to a smart saddle apparatus comprising multiple functions for enhancing security of the animal and the rider.

### BACKGROUND OF THE INVENTION

The saddle is a supportive structure for a rider or other load, fastened to an animal's back by a girth. The most common type is the saddle designed for a horse, but specialized saddles have been created for camels and other creatures. Based on the trend of the last years to create a more horse friendly equestrian sport, the saddle fit moves more and more into focus. Today, modern saddles come in a wide variety of styles, each designed for a specific equestrianism discipline, and require careful fit to both the rider and the horse.

Managing horses during hot weather can be a challenge for horse owners. Horse owners need to provide extra care during hot weather in order to decrease stress and maintain health and well-being of the horse as it is very difficult for the horse to dissipate in hot and humid weather.

Also, during back riding activities, riders need enhanced security measures to orient them while riding the animal and to guide them through in case they are lost in the forests or deserts for example. Traditional saddles failed to propose enhanced security measures for animals and riders during back riding activities.

### SUMMARY OF THE INVENTION

As a first aspect of the invention, there is provided a saddle apparatus adapted to be mounted on the back of an animal comprising:
a saddle housing comprising external walls, an internal cavity defined by the external walls and a seat portion for seating an animal rider;
a container compartment defined within the internal cavity of the saddle housing;
a fluid container adapted to be removably mounted inside the container compartment, the fluid container being adapted to store fluid; and
a fluid dispenser in fluid communication with the fluid container adapted to allow flow of fluid from the fluid container on the animal when the saddle apparatus is mounted on the back of the animal.

Preferably, the fluid dispenser comprises at least one nozzle adapted to enable the flow of fluid on the back of the animal when the saddle apparatus is mounted on the back of the animal.

Preferably, the fluid container comprises at least one opening adapted to receive the fluid for storage inside the fluid container.

Preferably, the saddle apparatus further comprises a thermometer adapted to measure the temperature of the fluid inside the fluid container and a user interface adapted to be connected to the thermometer for communicating the temperature measurement to the rider.

Preferably, the saddle apparatus further comprises a power supply and a transmitter adapted to transmit the temperature measurement to a remote device.

Preferably, the power supply is a solar-based power supply comprising a solar panel adapted to be mounted on the external wall of the saddle housing.

Preferably, the saddle apparatus further comprises a light detector, a lighting device and a power supply, the light detector being adapted to activate the lighting device in dark conditions.

Preferably, the light detector comprises a photo sensor and a diode, the diode being adapted to activate the lighting device when the photo sensor reflects dark conditions.

Preferably, the saddle apparatus further comprises a switch in connection with the lighting device for enabling a user to switch off/on the lighting device in such a manner that when the switch is turned off, the lighting device remains deactivated in dark conditions.

Preferably, the saddle apparatus further comprises a transceiver adapted to be connected to the switch for enabling a remote user to switch on/off the lighting device remotely.

Preferably, the power supply is a solar-based power supply comprising a solar panel adapted to be mounted on the external wall of the saddle housing.

Preferably, the saddle apparatus further comprises a gyroscope adapted to measure the angular orientation of the animal, the gyroscope comprising a user interface adapted to be mounted on the external walls of the saddle housing in front of the seat portion in a manner accessible to the rider while seated.

Preferably, the saddle apparatus further comprises a proximity detector, a camera, a power supply, and a user interface comprising a display, the proximity detector and the camera being adapted to be connected to the user interface, wherein the proximity detector is adapted to detect proximate objects and to communicate an alarm signal to the user interface when objects within a predefined distance range are detected, and wherein the camera is adapted to capture and send images to the display, wherein the display is adapted to be mounted on the external walls of the saddle housing in front of the seat portion in a manner accessible to the rider while seated.

Preferably, the power supply is a solar-based power supply comprising a solar panel adapted to be mounted on the external wall of the saddle housing.

Preferably, the saddle apparatus further comprises a heart pulse reader, a power supply and a user interface adapted to be connected to the heart pulse reader for measuring the heart pulse of the animal and for communicating the heart pulse measurement to the user interface, the user interface comprising a display adapted to be mounted at an external walls of the saddle housing in front of the seat portion in a manner accessible to the rider while seated.

Preferably, the saddle apparatus further comprises a transmitter adapted to be connected to the heart pulse reader for communicating the heart rate measurement to a remote device.

Preferably, the power supply is a solar-based power supply comprising a solar panel adapted to be mounted on the external wall of the saddle housing.

Preferably, the saddle apparatus further comprises a weighting device, a power supply and a user interface adapted to be connected to the weighting device for measuring the weight of the rider when seated on the seat portion and for communicating the weight to the user interface, the user interface comprising a display adapted to be mounted at an external walls of the saddle housing in front of the seat portion in a manner accessible to the rider while seated.

Preferably, the saddle apparatus further comprises a transmitter adapted to be connected to the weighting device for communicating the heart rate measurement to a remote device.

Preferably, the saddle apparatus further comprises a pad adapted to be removably coupled to the saddle housing.

### BRIEF DESCRIPTION OF THE DRAWINGS

FIG. 1 is side top view of the saddle apparatus in accordance with an embodiment of the invention;

FIG. 2 is a back top view of the saddle apparatus in accordance with an embodiment of the invention;

FIG. 3 is perspective view of the saddle apparatus illustrating a fluid container being inserted in a container compartment in accordance with an embodiment of the invention;

FIG. 4 is a side top view of a fluid container in accordance with an embodiment of the invention;

FIG. 5 is front top view of the saddle apparatus in accordance with an embodiment of the invention;

FIG. 6 is a bottom view of the saddle apparatus in accordance with an embodiment of the invention;

FIG. 7 is a top view of the saddle apparatus in accordance with an embodiment of the invention;

FIG. 8 illustrates the saddle apparatus and the pad in accordance with an embodiment of the invention;

FIG. 9 is a block diagram illustrating the electrical/electronic components of the apparatus according to an embodiment of the invention;

FIG. 10 is a block diagram illustrating the light detector, light device and switch according to an embodiment of the invention; and

FIG. 11 is a block diagram illustrating the electrical/electronic components of the apparatus according to another embodiment of the invention.

### DETAILED DESCRIPTION OF THE INVENTION

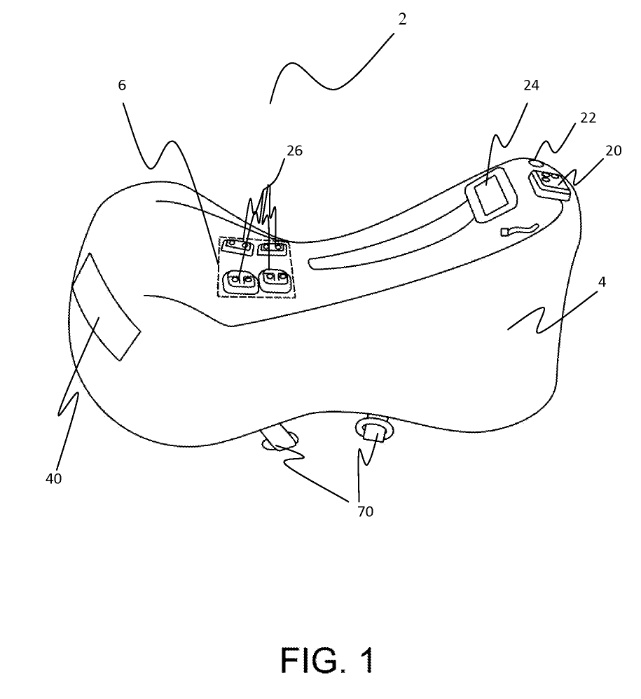

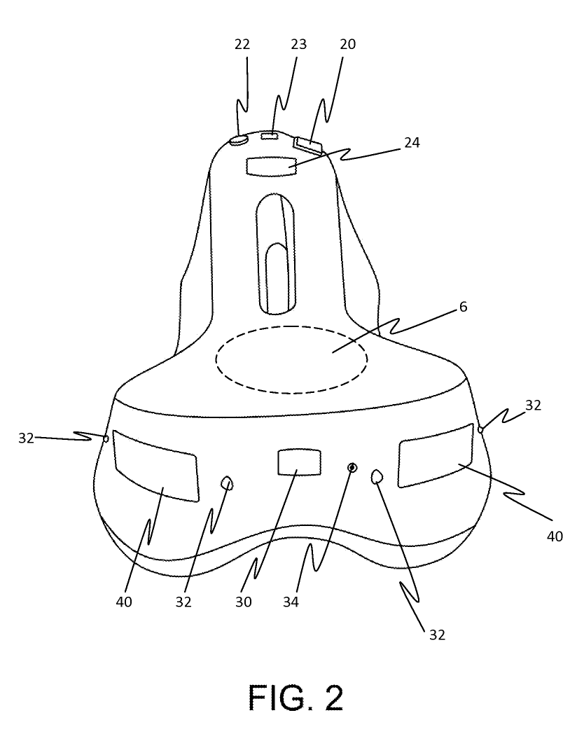

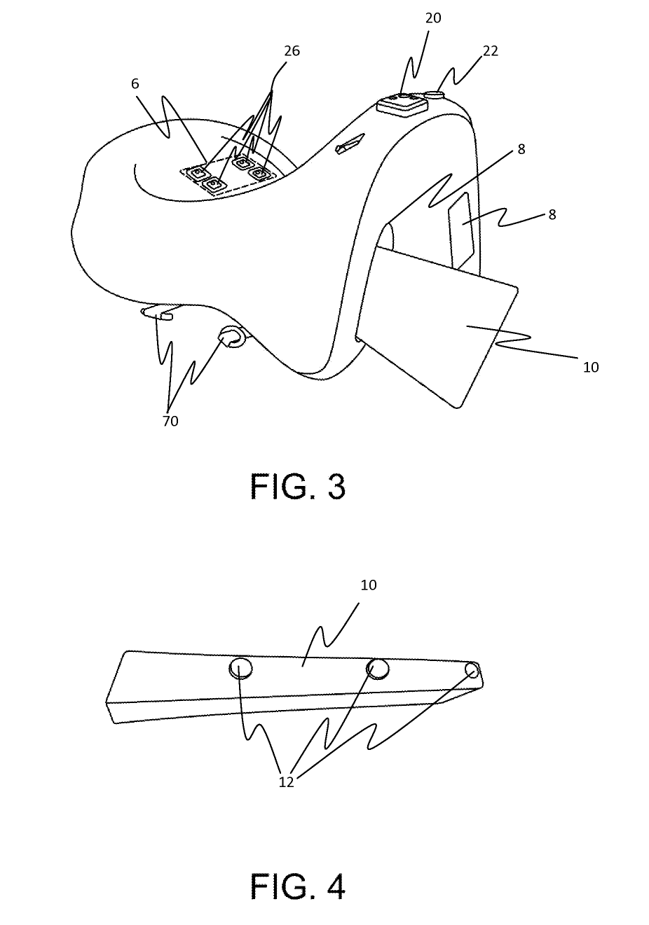

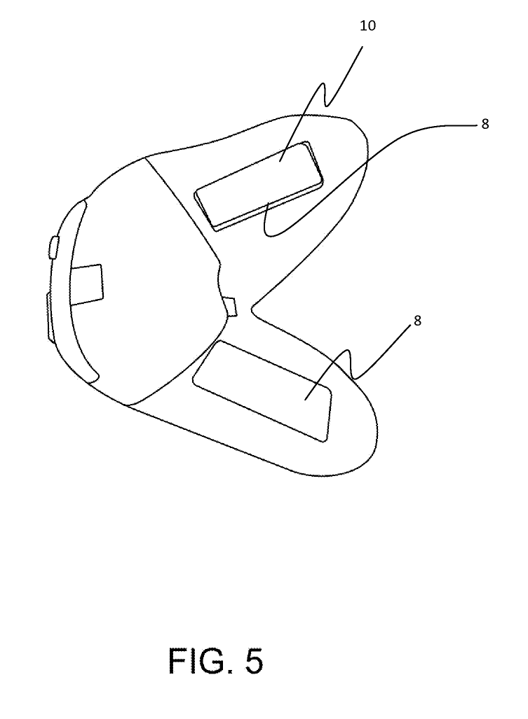

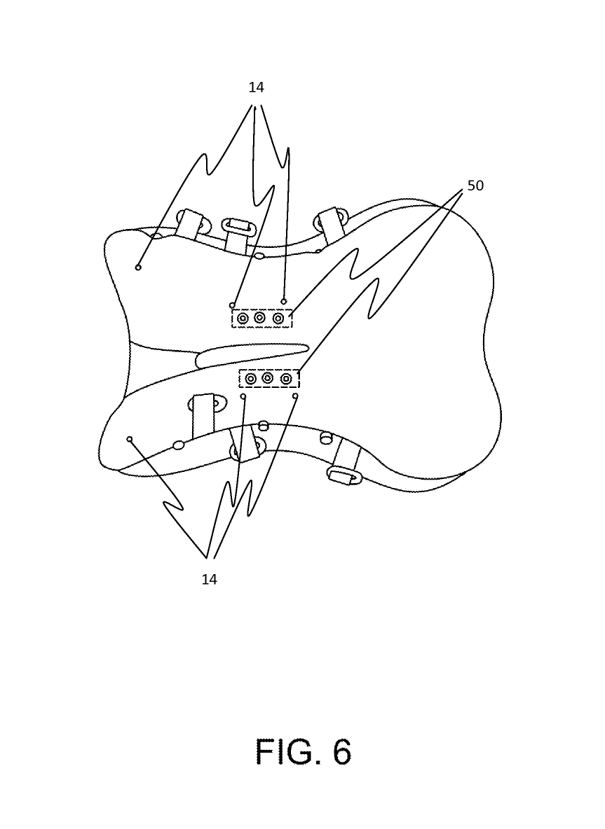

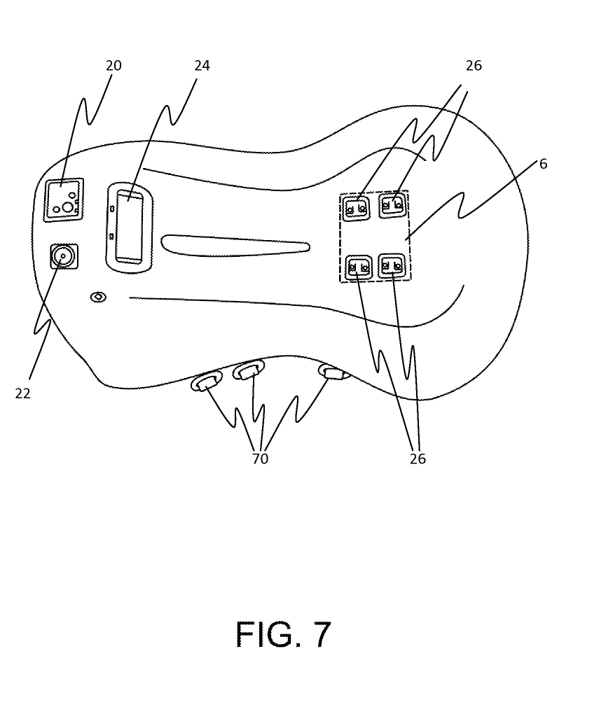

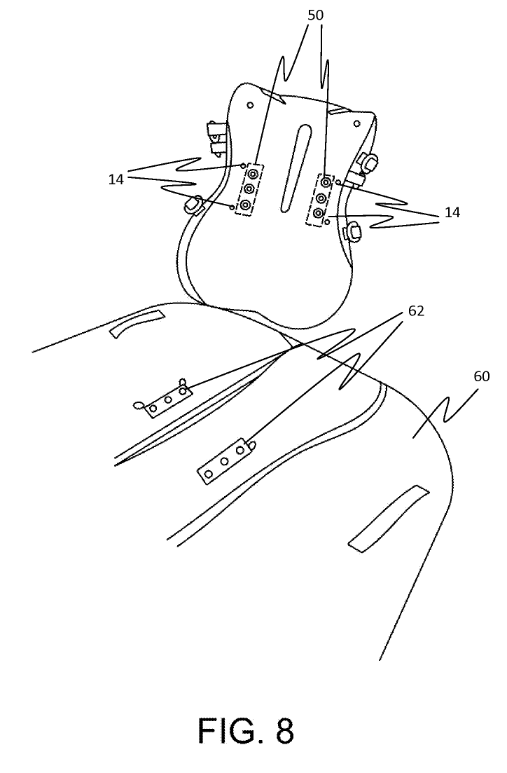

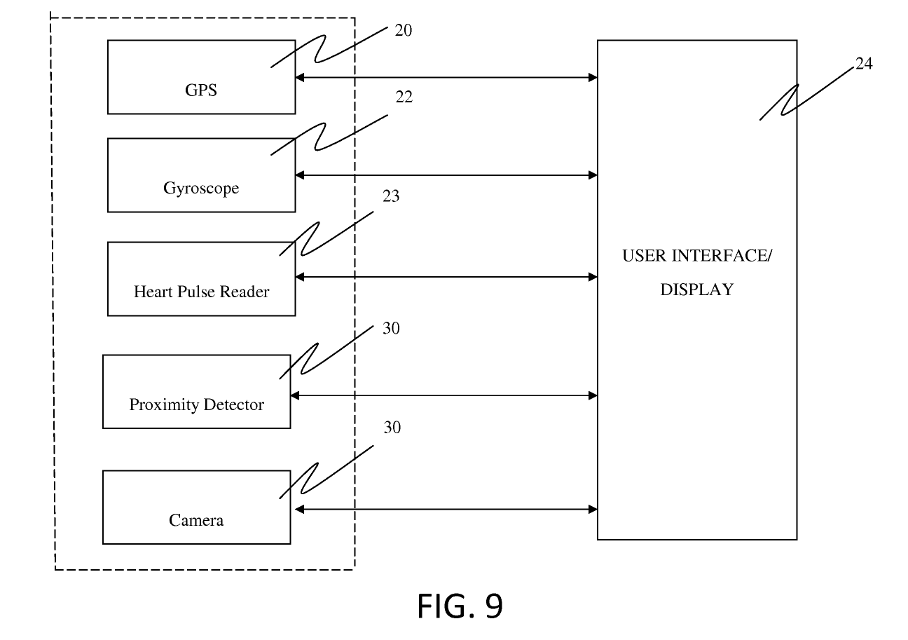

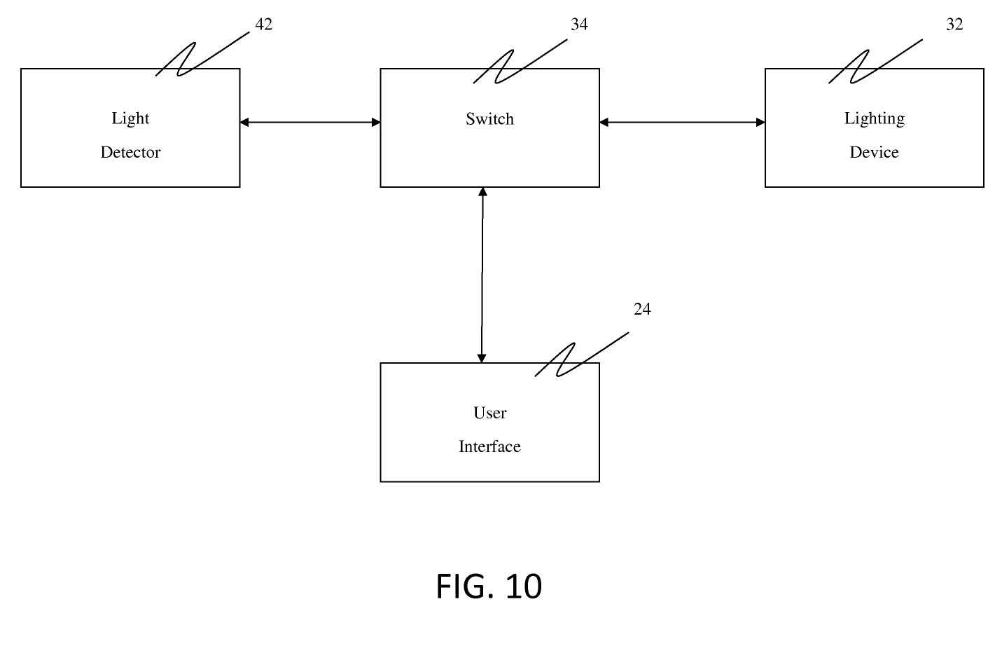

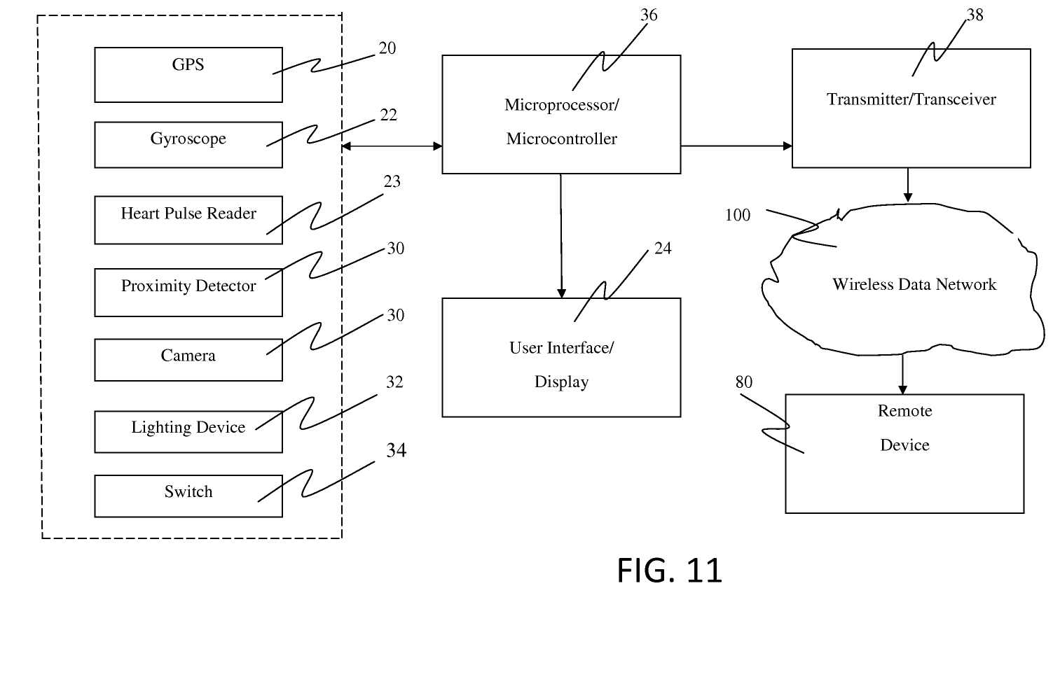

As illustrated in FIGS. 1 to 11, as a first aspect of the invention, there is provided a saddle apparatus 2 comprising a saddle housing 4, at least one fluid container 10 (referred to herein as the “fluid container”) and at least one fluid dispenser 14 (referred to herein as “the fluid dispenser”) in fluid communication with the fluid container 10. The saddle housing 4 comprises at least one container compartment 8 (referred to herein as ‘the container compartment”) adapted to receive the fluid container 10. The fluid container 10 is adapted to be removably mounted inside the container compartment 8 of the saddle housing 4. The fluid container 10 is removable and portable such that it can be removed from the container compartment 8 and ported to a remote location.

The fluid container 10 comprises at least one container opening 12 with a respective cover (referred to herein as “the container opening”) adapted to enable insertion of fluid inside the fluid container 10 for storage. The container opening is adapted to be closed using the cover. The fluid is preferably water which is filled inside the fluid container 10 through the container opening. The fluid container 10 is then adapted to be placed in a low temperature environment (such as a freezer) for freezing the fluid before it is mounted back inside the container compartment 8 of the saddle housing 4. When water is inserted inside the fluid container and being frozen, ice is formed inside the fluid container 10.

The walls of the fluid container 10 are preferably made of a rigid material slightly dilatable such as plastic to enable the dilatation of the walls when the fluid inside the container 10 is converted into a solid state after being frozen. The walls of the fluid container 10 can however be made of any other suitable material such as stainless steel. Reinforced plastic is however is a preferred material due to its dilatation and low weight properties in addition to its strength properties which are convenient for this application in order to reduce the weight load of the saddle 2 over the animal back when the fluid container 10 is mounted inside the container compartment 8 of the saddle housing 4. The fluid container 10 can take any shape. A suitable shape can for example be a rectangular shape where the fluid container 10 would have the shape of a rectangular box is this case. The shape of the fluid container 10 is adapted to the shape of the container compartment 8.

The fluid dispenser 14 is adapted to be in fluid communication with the fluid container 10. The fluid dispenser 14 is adapted to dispense fluid stored inside the fluid container 10 to the outside environment. When the saddle 2 is mounted on the animal back, the fluid dispenser 14 is adapted to dispense the fluid enabling the flow of fluid on the animal's body in order to cool up the animal. The fluid dispenser 14 can comprise one or more nozzles or spray dispensers. The fluid dispenser 14 can also comprise one or more valves adapted to regulate the flow of fluid.

According to an embodiment of the invention, the fluid is water. In operation, the fluid container 10 is first filled in with water then being kept in a freezer for freezing the water for forming ice inside the fluid container 10. The fluid container is then placed inside the container compartment 8 of the saddle housing 4. During back riding, the ice is melted progressively through a period of time into water, where the water is being dispensed on the animal through the fluid dispenser 14. As the fluid container 10 is in contact with the animal body, the temperature of the animal directly affects the melting speed of the ice into water. If the animal is in a race for example, the temperature of his body rises and the melting process is expedited which results in more water being formed inside the fluid container and being dispensed on the animal in a given period of time. This example assumes that the fluid is water, however other types of fluid can be used in the same manner. In an embodiment of the invention, the animal is a horse or camel. As these animals are usually used for long journeys in hot weather areas, the use of this apparatus as particularly useful to cool up the animal from heat.

The saddle apparatus 2 preferably further comprises a thermometer and a user interface 24. The thermometer is adapted to measure the temperature of the fluid inside the fluid container. The thermometer is preferably adapted to be located at one of the external walls of the fluid container 10, however, it can also be adapted to be located inside the fluid container 10. The user interface 24 is adapted to be connected to the thermometer for communicating the temperature of the fluid to the rider. The communication of the temperature to the rider enables the latter to determine whether the fluid remains sufficiently cool during riding activities and to take a decision based on the temperature of the fluid and the animal physical condition. The user interface 24 preferably comprises a display which is preferably an interactive display allowing to read instructions from the user. The display is preferably secured at the front side of the saddling housing 4 in such a manner to be easily accessible to the rider during back riding.

The fluid dispenser 14 can be a manual or automatic dispenser. In the latter case, the fluid dispenser 14 is adapted to be connected to the user interface and to be remotely controlled by the rider using the user interface 24. Based on the physical condition of the animal, the rider can control the automatic fluid dispenser 14 to regulate the flow of fluid being dispensed on the animal. This enables the rider to take a decision on whether to dispense fluid on the animal based on certain criteria such as the animal physical condition, the amount of fluid remaining inside the fluid container and the temperature of the fluid inside the fluid container 10. For example, if the temperature inside the fluid container is high, there might be no benefit in dispensing water on the animal which can have an adverse affect on the animal's condition.

The regulation of the fluid dispenser 14 can be conducted by the rider using the user interface 24. The automatic dispenser can also be configured to automatically regulate the flow of water based on the fluid temperature as read by the thermometer. In an embodiment of the invention, the saddle apparatus 2 further comprises a microprocessor/microcontroller 36 in communication with the automatic dispenser and the thermometer for coordinating the dispenser activities. For example, the fluid dispenser 14 can be configured to dispense water when the fluid temperature falls within a certain predefined temperature range and to be closed otherwise. The fluid dispenser 14 can also be adapted to regulate the amount of the flow of water to be dispensed based on a predefined temperature range.

In an embodiment of the invention, the saddle apparatus 2 further comprises a gyroscope 22. The gyroscope 22 is used by the rider to measure the angular orientation of the animal so that a decision is taken for preserving the angular momentum of the animal. The gyroscope 22 can have its own user interface or can be connected to the user interface 24 of the saddle apparatus 2 to communicate the readings to the user. The gyroscope 22 would enable the rider to take a decision as to balance any swaying while riding the horse or the like, and to apply any necessary stabilizing force to help the rider stay upright on the saddle even when tipping or wobbling.

The gyroscope 22 is also adapted to detect if the animal has flipped based on the angular position of the animal. In one embodiment, the saddle apparatus 2 further comprises a wireless transmitter having an antenna adapted to send data to a remote device 80. The gyroscope 22 is preferably adapted to be in communication with the transmitter for sending the gyroscope 22 readings to the remote device 80. These readings would allow determining if the animal has flipped so that required relief actions are taken.

In an embodiment of the invention, the saddle apparatus 2 further comprises a proximity sensor 30 and a camera 30 adapted to be in communication with the user interface 24. The proximity sensor 30 and the camera 30 are preferably adapted to be mounted at the back side wall of the saddle housing 4. The proximity sensor 30 is adapted to detect in proximity objects and to send an alarm signal to the user interface 24 if objects are detected within a predefined distance range. The proximity sensor 30 is of particular importance in race events so that any in proximity racers are detected and notified to the rider. The camera 30 is also adapted to capture and transmit images to the user interface 24 allowing the rider to have a view of the surrounding environment (rear and/or side view for example) without turning his/her head which can be of high utility during races. The saddle apparatus 2 may further comprise a camera charger 34.

In an embodiment of the invention, the saddle apparatus 2 further comprises a Global Positioning System device (GPS) 20. The GPS 20 is adapted to be connected to the user interface 24 for communicating the real time location to the rider. Preferably, the GPS 20 comprises a navigation application with preconfigured maps for enabling the rider to navigate through. The maps can comprise a racing or journey map for example adapted for the specific activities of the rider. Preferably, the GPS 20 is further adapted to be connected to the transmitter for transmitting the location of the animal/rider to a remote monitoring device 80. This would allow a remote controller to locate the location of the animal in real time and to take actions in case of emergency. In case of loss of the animal/rider, this would enable the remote controller to determine the location of the animal.

In an embodiment of the invention, the saddle apparatus 2 further comprises a weighing device 26 adapted to be in communication with the user interface 24 for measuring the weight of the rider and for communicating the information to the user interface 24. The weighing device 26 is adapted to be mounted in such a manner to measure the weight of the rider while seated on the seat portion 6 of the saddle housing 4. The weighing device 26 is preferably mounted within the saddle housing 4 underneath the seat portion 6. The sensors of the weighing device 26 face upwardly at the seat portion 6. The weighing device 26 can be connected to the transmitter 38 for transmitting the weight of the rider to the remote device 80.

In an embodiment of the invention, the saddle apparatus further comprises a heart pulse reader 23 adapted to measure the heart rate of the animal. The heart pulse reader 23 is adapted to be in communication with the user interface 24 for communicating the heart pulse rate of the animal to the rider in real time. The heart pulse reader 23 is adapted to be connected to electrodes adapted to be placed on the animal body underneath the saddle housing 4. The heart pulse reader 23 is preferably adapted to be in communication with the transmitter 38 for transmitting the heart pulse rate of the animal to the remote device 80 for remote monitoring 80. This can be useful during race activities or other activities which require the close monitoring of the animal's heart rate condition in real time for example.

In an embodiment of the invention, the saddle apparatus 2 further comprises a light detector 42 and a lighting device 32. The light detector is adapted to be in communication with the lighting device 32 for activating the lighting device 32 during low light conditions, for example during night time. The light detector is adapted to have a first resistance in light conditions and a second resistance in dark conditions. The light detector preferably comprises a photo sensor and a diode adapted to activate the lighting device 32 in low light conditions, such as at night time. The lighting device 32 is adapted to diffuse light when activated. The light diffused is adapted to be visible from a remote location for remotely locating the animal in dark conditions. The lighting device 32 is preferably mounted at the rear portion of the saddle housing 4. The lighting device 32 preferably comprises a switch 34 for enabling the deactivation of the lighting device 32 so as to restrict the lighting device 32 from operating even in dark conditions. This is useful for example when the animal is in the farm and there is no need for this function to be enabled. The switch 34 is preferably connected to the user interface 24 for enabling the user to switch on/off the lighting device 32 using a dedicated command at the user interface 24. The switch 34 can also be turned off/on remotely by the remote device 80 as explained below.

The saddle apparatus 2 further comprises a power supply unit 40 adapted to be connected to the electronic/electrical components for supplying power thereto. In an embodiment of the invention, the power supply device 40 is adapted to be connected to the user interface 24, the GPS 20, the heart pulse reader 23, the transmitter, the light detector 42, the lighting device 32, the proximity sensor 30, the camera, the microprocessor/microcontroller 36, the thermometer and the gyroscope 22 (if needed). The power supply is preferably a solar-based power supply comprising at least one solar panel 40 (referred to herein as “the solar panel”). The solar panel 40 is adapted to be mounted at the rear side portion of the saddle housing 4 and adapted to be connected to the electronic/electrical components using electrical wires. The internal portion of the saddle housing 4 is adapted to receive the wires extended between the solar-based power supply and the electronic/electrical components. The solar panel 40 is adapted to have suitable dimensions to fit within the rear side of the saddle housing 4. The solar panels 40 are adapted to be inclined in a suitable inclination angle to maximize light/sun capturing.

In another embodiment, the power supply device 40 comprises a battery for supplying electrical energy to the different electrical/electronic components either in substitution or in addition to the solar panel 40. For example, the battery can be adapted to supply power to the components when the solar panel 40 is in low capacity and does not provide sufficient energy capable of operating the components, such as in night time for example.

In an embodiment of the invention, the microprocessor/microcontroller 36 is adapted to be in communication with at least a part of the electronic components for coordinating activities thereof in accordance with a preconfigured configuration. The microprocessor/microcontroller 36 is preconfigured using computer instructions in this respect. This can be done through a computer application running on the microprocessor for example. The microprocessor/microcontroller 36 is preferably connected to the user interface 24, the heart pulse reader 23, the transmitter/transceiver 38, the proximity detector 30, the camera, the GPS 20, the thermometer, the gyroscope 22, the lighting device 32. The microprocessor is also preferably connected to the fluid dispenser 14 (in case of an automatic fluid dispenser). These electronic components can also be directed connected to the transmitter/transceiver 38 depending on the application. The transmitter/transceiver 38 is adapted to be connected to a wireless data network 100 for communicating with the remote device 80.

In an embodiment of the invention, the microprocessor/microcontroller 36 is adapted to generate and send an alarm signal to the user interface 24 and/or to the remote device 80 when the heart rate of the animal exceeds a predefined heart rate threshold, and/or when the angular position of the animal exceeds a predefined angular position threshold, and/or when the temperature of the fluid exceeds a predefined temperature threshold, and/or when the amount of power available by the power supply unit is below a predefined energy threshold, and/or when the animal is outside a predefined geographical zone and/or when the animal is within a predefined danger distance from an in proximity object and/or when the weight measured by the weighing device 26 is below a predefined threshold for a certain period of time which can be indicative of the possibility of a horse rider fell for example.

In an embodiment of the invention, the user interface 24 is adapted to enable the user to read of the components and to request the communication of this information to the display and/or transmission to the remote device 80 and/or enable or disable desired functions such as the switching off the lighting device 32. In another embodiment, the microprocessor/microcontroller 36 is adapted to receive instructions from the remote device 80 as to enable/disable certain functions (such as switching off the lighting device) or to request the reading and transmission of certain information such as the location of the animal, the heart rate of the animal and the weight of the rider. The communication to/from the remote device 80 is done through the transmitter/transceiver 38.

In an embodiment of the invention, the saddle apparatus 2 further comprises belts 70 to fasten the saddle apparatus 2 on the back of an animal.

In an embodiment of the invention, the saddle apparatus 2 further comprises a pad 60 adapted to be removably coupled to the saddle housing 4. The pad 60 comprises first coupling members 62 and the saddle housing 4 further comprises second coupling members 50 adapted to be coupled to the first coupling members 62 of the pad 60. The coupling of the pad 60 to the saddle housing 4 allows for securely holding the pad 60 in place. The first coupling members 62 can be male button clips and the second coupling members 50 can be female button clips for example. The saddle housing 4 can be made of any material which may include but not limited to, leather, mohair, or nylon. The pad 60 can be made of any suitable material, preferably cotton.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

1. A saddle apparatus adapted to be mounted on the back of an animal comprising:
a saddle housing comprising external walls, an internal cavity defined by the external walls and a seat portion for seating an animal rider;
a container compartment defined within the internal cavity of the saddle housing;
a fluid container adapted to be removably mounted inside the container compartment, the fluid container being adapted to store fluid; and
a fluid dispenser in fluid communication with the fluid container adapted to allow flow of fluid from the fluid container on the animal when the saddle apparatus is mounted on the back of the animal.

2. The saddle apparatus of claim 1 wherein the fluid dispenser comprises at least one nozzle adapted to enable the flow of fluid on the back of the animal when the saddle apparatus is mounted on the back of the animal.

3. The saddle apparatus of claim 2 wherein the fluid container comprises at least one opening adapted to receive the fluid for storage inside the fluid container.

4. The saddle apparatus of claim 1 further comprising a thermometer adapted to measure the temperature of the fluid inside the fluid container and a user interface adapted to be connected to the thermometer for communicating the temperature measurement to the rider.

5. The saddle apparatus of claim 4 further comprising a power supply and a transmitter adapted to transmit the temperature measurement to a remote device.

6. The saddle apparatus of claim 5 wherein the power supply is a solar-based power supply comprising a solar panel adapted to be mounted on the external wall of the saddle housing.

7. The saddle apparatus of claim 1 further comprising a light detector, a lighting device and a power supply, the light detector being adapted to activate the lighting device in dark conditions.

8. The saddle apparatus of claim 7 wherein the light detector comprises a photo sensor and a diode, the diode being adapted to activate the lighting device when the photo sensor reflects dark conditions.

9. The saddle apparatus of claim 8 further comprising a switch in connection with the lighting device for enabling a user to switch off/on the lighting device in such a manner that when the switch is turned off, the lighting device remains deactivated in dark conditions.

10. The saddle apparatus of claim 9 further comprising a transceiver adapted to be connected to the switch for enabling a remote user to switch on/off the lighting device remotely.

11. The saddle apparatus of claim 10 wherein the power supply is a solar-based power supply comprising a solar panel adapted to be mounted on the external wall of the saddle housing.

12. The saddle apparatus of claim 1 further comprising a gyroscope adapted to measure the angular orientation of the animal, the gyroscope comprising a user interface adapted to be mounted on the external walls of the saddle housing in front of the seat portion in a manner accessible to the rider while seated.

13. The saddle apparatus of claim 1 further comprising a proximity detector, a camera, a power supply, and a user interface comprising a display, the proximity detector and the camera being adapted to be connected to the user interface, wherein the proximity detector is adapted to detect proximate objects and to communicate an alarm signal to the user interface when objects within a predefined distance range are detected, and wherein the camera is adapted to capture and send images to the display, wherein the display is adapted to be mounted on the external walls of the saddle housing in front of the seat portion in a manner accessible to the rider while seated.

14. The saddle apparatus of claim 13 wherein the power supply is a solar-based power supply comprising a solar panel adapted to be mounted on the external wall of the saddle housing.

15. The saddle apparatus of claim 1 further comprising a heart pulse reader, a power supply and a user interface adapted to be connected to the heart pulse reader for measuring the heart pulse of the animal and for communicating the heart pulse measurement to the user interface, the user interface comprising a display adapted to be mounted at an external walls of the saddle housing in front of the seat portion in a manner accessible to the rider while seated.

16. The saddle apparatus of claim 15 further comprising a transmitter adapted to be connected to the heart pulse reader for communicating the heart rate measurement to a remote device.

17. The saddle apparatus of claim 16 wherein the power supply is a solar-based power supply comprising a solar panel adapted to be mounted on the external wall of the saddle housing.

18. The saddle apparatus of claim 1 further comprising a weighting device, a power supply and a user interface adapted to be connected to the weighting device for measuring the weight of the rider when seated on the seat portion and for communicating the weight to the user interface, the user interface comprising a display adapted to be mounted at an external walls of the saddle housing in front of the seat portion in a manner accessible to the rider while seated.

19. The saddle apparatus of claim 18 further comprising a transmitter adapted to be connected to the weighting device for communicating the heart rate measurement to a remote device.

20. The saddle apparatus of claim 1 further comprising a pad adapted to be removably coupled to the saddle housing.
